(19) United States
(12) Patent Application Publication
(10) Pub. No.: US 2004/0002847 A1
(43) Pub. Date: Jan. 1, 2004

(54) Method for creating and displaying signaling eye-plots

(75) Inventors: Robert D. Cole, Malden, MA (US); William B. Gist III, Chelmsford, MA (US)

Correspondence Address: LAHIVE & COCKFIELD, 28 STATE STREET, BOSTON, MA, 02109, US

(73) Assignee: Sun Microsystems, Inc., Palo Alto, CA

(21) Appl. No.: 10/180,152

(22) Filed: Jun. 26, 2002

(51) Int. Cl. G06F 9/45

(52) U.S. Cl. 703/22

(57) ABSTRACT

A present invention discloses an automated method to generate an eye-plot for signals produced by a simulation or captured hardware results. The automated approach is customizable in that the designer may specify input parameters to customize the analysis to fit the needs of the user. The eye-plot is then generated. The eye-plot may be output on the printer, displayed on the video display or even stored in secondary storage for subsequent review and use.

### FIELD OF THE INVENTION

The present invention relates generally to signaling performance analysis for electrical components and more particularly to an automated approach for displaying signaling eye-plot graphs.

### BACKGROUND OF THE INVENTION

During the design of electrical components, such as microprocessors, designers generally wish to examine the signaling that results from the design. Designers generally view a plotted series of consecutive signal voltage values as a “wave”. Combining the signals of numerous consecutive cycles provides a visual qualitative picture of timing measurements that is not easily observable from numerical timing summaries alone. The resulting picture is known an “eye-plot”.

The signaling produced by a given electrical component design may be simulated using commercially available simulation packages. An example of such a simulation package is the hspice simulator sold by Avant! Corporation of Fremont, Calif. The commercially available simulation packages generally produce simulation results in the form of representations of respective signals employed in the simulation. A signal typically is represented in these packages by a series of voltage or current values and time values.

The existing methods involve repeatedly overlaying one cycle's wave patterns on the top of another cycle's wave pattern. The existing methods assume ideal clock cycles but clock jitter adds error in the proximity of a given set of waves to the actual clocking events. This method displays the wave patterns from the entire simulation. Another conventional method is to write a customized script that is executed by a computer to display a particular set of simulation results. Unfortunately, these methods are cumbersome, time-consuming and prone to human error. Also, existing methods only plot data node voltages relative to global power supply nodes and do not display data node voltages relative to a switching reference voltage node or complementary data node.

### SUMMARY OF THE INVENTION

The present invention addresses the above-described limitations of conventional approaches to displaying simulation results of electrical components to perform signaling performance analysis. In particular, the present invention provides an automated method for generating the eye-plot of signals produced by a simulation or captured hardware results. The automated approach is generalizable in that it may be applied to a number of different signals and even to different simulation result outputs. The automated approach is customizable in that the designer may specify input parameters to customize the analysis to fit the needs of the designer.

In accordance with one aspect of the present invention, a method is practiced in an electronic device. In this method, an input file is provided from a simulation result of an electrical component. Initially, the input file is checked for validity. The simulation result contains information regarding a data signal and a clock signal. The data signal and the clock signal may be single-ended or differential. User-specified parameters are received at the automated tool and applied to determine the type and the characteristics of an eye-plot by the tool. The selective algorithm selects the most relevant waves from the entire simulation for sparse plots. The eye-plot is generated based on user-input parameters.

In accordance with another aspect of the present invention, a method of displaying results of simulation of an electrical component with an automated processing facility. An automated processing facility processes the results of the simulation or captured output and provides the signaling eye-plot graph.

In accordance with another aspect of the present invention, a user interface is defined for simplicity, ease of use and conciseness. All user-input appears in report files so that it can be checked and associated with the eye-plot generated. These steps help to assure process integrity and uniformly measured and repeatable results.

### BRIEF DESCRIPTION OF THE DRAWINGS

FIG. 1 is a block diagram illustrating workflow in an illustrative embodiment of the present invention;

FIG. 2 is a block diagram of a computer system suitable for practicing the illustrative embodiment;

FIG. 3 is a flow chart that provides an overview of the steps that are performed in the illustrative embodiment;

FIG. 4 is a more detailed flow chart illustrating the steps that are performed for a user to enter parameters in the illustrative embodiment;

FIG. 5 is a flow chart illustrating the steps that are performed for a sparse eye-plot's wave selection with variable maximum waves per parameter;

FIG. 6 shows an example of a full “fasteye” eye-plot produced in accordance with the illustrative embodiment;

FIG. 7 shows an example of a sparse “fasteye” eye-plot produced in accordance with the illustrative embodiment;

FIG. 8 shows an example of a sparse “wavenames” eye-plot produced in accordance with the illustrative embodiment; and

FIG. 9 shows an example of a full “matrix” eye-plot produced in accordance with the illustrative embodiment.

### DETAILED DESCRIPTION

An illustrative embodiment of the present invention provides a process facility for automatically generating an eye-plot from output of a simulator or from captured electrical component results. The automated approach is customizable in that the designer may specify input parameters to the user-input file to customize the analysis to fit the need of the user. The eye-plot can be displayed in a wave viewer, printed on the printer or even stored in secondary storage for subsequent review and use.

Signals may be single-ended (“non-differential”) or differential or may have a more complex encoding. With single-ended signals, the magnitude of the voltage of the signal relative to a common, explicit or implicit, switching reference voltage is used to determine whether the signal is in a logically high state (i.e., a logic one state) or a logically low state (i.e., a logic zero state). In contrast, with a differential signal, it is the polarity (positive or negative) of the resulting voltage when node bar voltage is subtracted from node voltage of differential data pairs. Differential signaling allows for quicker transitions between states and enables the voltage range between logic states to be of less magnitude than with single-ended signaling. More complex state encoding may include the use of multiple voltage levels (such as four or more levels) or timing encodings.

For purposes of the discussion below, a “clock event” refers to a transition of the clock signal from either a logically low state to a logically high state or a transition from a logically high state to a logically low state. Whether one of these transitions or both of these transitions constitute “clock events” is depends on user defined data rate.

When simulations employ differential clocking schemes that can use either a Double Data Rate (DDR) or a Single Data Rate (SDR). DDR recognizes clock edges when the differential clocks cross, regardless of clock_high crossing above clock_low, or clock_low crossing above clock_high. Considering a number of consecutive clock crossings using DDR will result in twice as many clock edges being analyzed as considering the same consecutive clock crossings using SDR.

The present invention provides an eye-plot that is made up of waves that have exactly the same temporal proximity to the plotted clock to the actual clock edge in the original simulation. The temporal alignment allows Data-Jitter, Setup and Hold measurements to be made directly from the eye-plot that will exactly match Data-jitter, Setup and Hold measurements of the original simulation.

For “fasteye”,“matrix” and “wavenames” eye-plot, each clock occurs at a time element that is equal to zero. It appears in the center of the eye-plot. All time elements to the left of zero are negative and all time elements to the right of zero are positive.

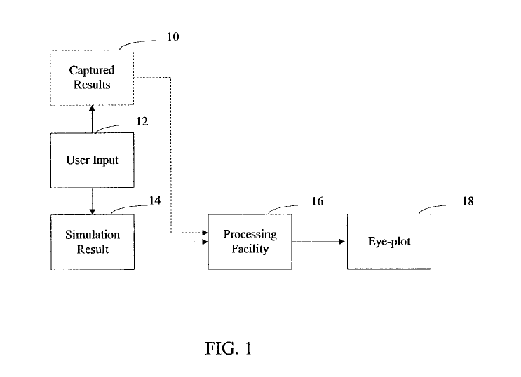

FIG. 1 is a block diagram illustrating high level interaction among components in the illustrative embodiment of the present invention. The simulation result 14 is the result of a simulation by a simulation package and includes the data (such as waveform representations) regarding various signals. The simulation result 14 is processed by the processing facility 16. Alternatively, the processing facility 16 may process captured results 10 from an electrical component. The processing facility 16 is, in the illustrative embodiment, a software tool for processing the simulation result 14 or captured results 10. Those skilled in the art will appreciate that the processing facility 16 need not be implemented as a software facility but may be implemented in firmware, in hardware or in a software/hardware hybrid. The simulation result 14 or the captured results 10 receives user-input 12 that the processing facility 16 employs to configure the eye-plot generation. The operation of the processing facility 16 and the nature of the user-input 12 will be described in more detail below. The results of the process are incorporated into an eye-plot 18. The eye-plot 18 may be printed, shown on a video display or even stored for subsequent viewing. In the illustrative embodiment, the eye-plot 18 shows the signals of numerous consecutive cycles providing a visual qualitative picture of timing measurements.

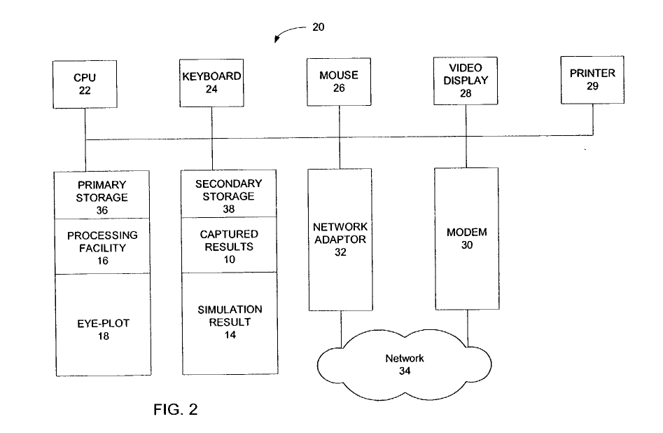

The processing facility 16 may execute on a computer system or other suitable type of intelligent electronic device. FIG. 2 shows a block diagram of one suitable computer system 20 for practicing the illustrative embodiment. Those skilled in the art will appreciate that the processing facility may run on a number of different types of electronic devices, including but not limited to a personal computer, a laptop computer, a workstation, a server computer system, a mainframe computer system, a mini-computer system, a personal digital assistant (PDA), an intelligent pager, a telephone or a wireless computer.

The computer system 20 of FIG. 2 includes a central processing unit (CPU) 22 for overseeing activities within the computer system. The processing facility 16 runs on the CPU 22. The computer system 20 may include a keyboard 24, a mouse 26, a video display 28, a printer 29 and/or other varieties of peripheral devices. The computer system 20 may also include a modem 30 and a network adapter 32 for communicating with a network 34 to gain access to remote resources.

The computer system 20 includes a primary storage 36 and secondary storage 38. The primary storage 36 and the secondary storage 38 may include magnetic or optical storage media, including removable storage media. The primary storage 36 may include a copy of the processing facility software 16 and the eye-plot 18. The secondary storage 38 may include a copy of the simulation result 14 that is processed in a processing facility 16.

Those skilled in the art will appreciate that the configuration of the computer system 20 shown in FIG. 2 is intended to be merely illustrative and not limiting of the present invention. The present invention may be practiced with computer systems that includes different components from those shown in FIG. 2. It should be appreciated the computer system 20 may be a multiprocessor system, and in some embodiments, the processing facility may be executed a distributed fashion.

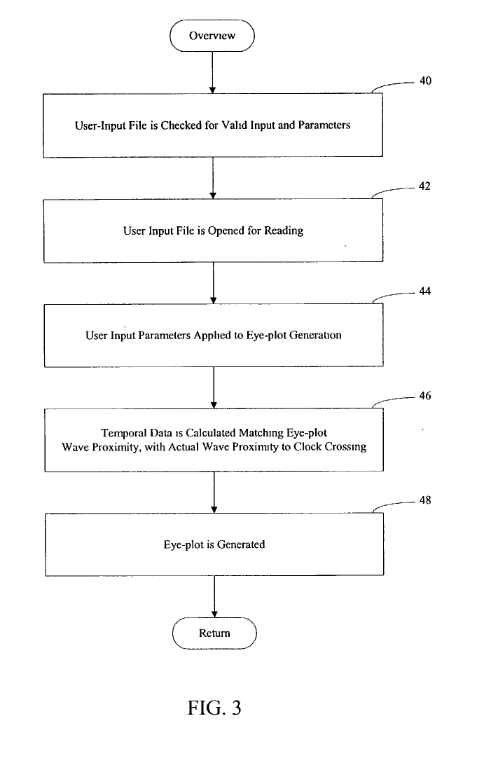

FIG. 3 is a flow chart that provides a high level overview of the steps performed in the illustrative embodiment of the present invention in processing the simulation result 14 or the captured results 10 with the processing facility 16 to produce an eye-plot 18. The user-input 12 may be provided by way of a user interface that prompts the user to provide the requested information. Alternatively, the user-input may be incorporated into a file or other structure that is processed by the processing facility 16.

The following steps are completed to generate the eye-plot. First, the user-input file is checked for valid input (step 40 in FIG. 3). The valid user-input contains parameters for the eye-plot as well as captured results 10 or simulation result 14. Second, the simulation result or captured results are opened for reading (step 42). Third, the user-input parameters are applied to eye-plot generation (step 44). Fourth, temporal data is calculated for the eye-plot (step 46). Last, the eye-plot is generated (step 48). The eye-plot can be display on the video display 29, such as a computer monitor, or printed on the printer 29 or saved to file.

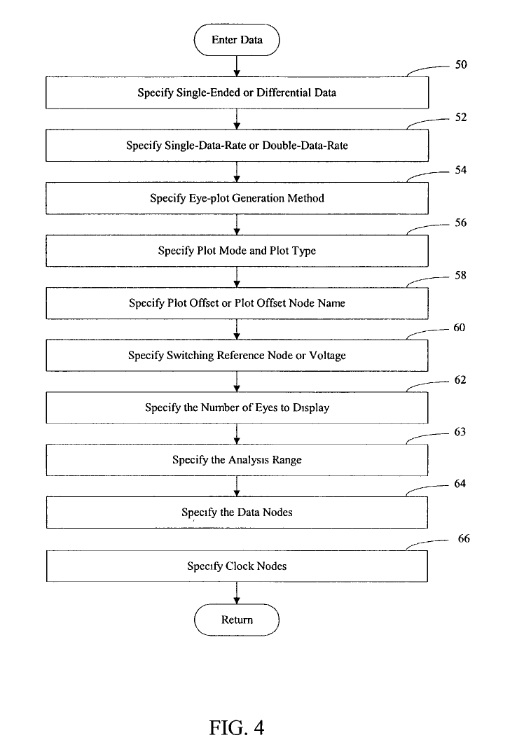

FIG. 4 is a flow chart illustrating in more detail the steps that are performed when the user enters data. Initially, the user specifies the mode of the data (step 50 in FIG. 4). In particular, the user specifies whether the data is a differential data or a single-end data. For single-ended data, an eye-plot can be made from a single data node or from multiple data nodes. For differential data, an eye-plot can be made from a single differential pair of data nodes or from multiple pairs of differential data nodes.

The user specifies the mode of the data rate (step 52). In particular, the user specifies whether the clock mode is a single data rate where only a rising edge or only a falling edge is evaluated, or a double data rate where both the rising edge and the falling edge are evaluated.

The user specifies the eye-plot generation method (step 54). In particular, the user specifies a selection from among the choices of ‘fasteye’ eye-plot, ‘wavenames’ eye-plot or ‘matrix’ eye-plot for the eye-plot generation method. More than one eye-plot generation method can be specified.

The user specifies the plot mode and plot type (step 56). The plot type is explicitly selected by user for differential data plots, but not for single-ended data plots since type is implicit. In particular, plot mode can be specified as full or sparse. A full plot shows the entire wave's patterns and a sparse plot limits the number of waves.

For differential data, the plot type can be specified as either absolute or relative. An absolute plot displays the waves representing node voltage and nodebar voltage separately. A relative plot displays the wave resulting from the difference between node voltage minus nodebar voltage.

For single-ended data, all plots are implicitly relative plots. A feature called Plot Vref is used. Plot Vref can be a data node or a value. Data voltage minus Plot Vref is plotted in the eye-plot. Absolute plots can be achieved by specifying Plot Vref as zero.

The user may specify the plot offset or the plot offset node name (step 58). For either absolute or relative plots, there is an option that provides plot offset. The plot offset, that can be either a data node or specified value, is subtracted from the absolute or relative plot and the results are shown in the eye-plot.

The user specifies the switching reference node or voltage (step 60). The reference node or voltage specifies the reference voltage in the electrical circuit being simulated. The switching voltage reference is used for magnitude comparison with data signal(s) in determining signal state values.

The user specifies the number of eyes to be plotted (step 62). The user can choose one or multiple eyes to be generated. The multiple eyes in the eye-plot show the surrounding timing events. The user can view longer history and future events by specifying more eyes to be plotted.

The user specifies the analysis range (step 63). The analysis range is the specific range of consecutive clocks in the original simulation from which the analysis and eye-plot are generated.

The user specifies the data nodes (step 64). The data nodes refer to a point in the electrical circuit that is being monitored. The illustrative embodiment of present invention may be applied to multiple data nodes or even to just a single data node.

Lastly, the user specifies the clock nodes (step 66).

Once the user has entered the parameters for the eye-plot in the user-input file, the user-input file is processed by the processing facility 16. Error checks are performed on the user-input file to ensure that there is no erroneous data or parameters. The eye-plot 18 is then generated. The eye-plot 18 may be output on the printer 29, displayed on the video display 28 or even stored in secondary storage 38 for subsequent review and use.

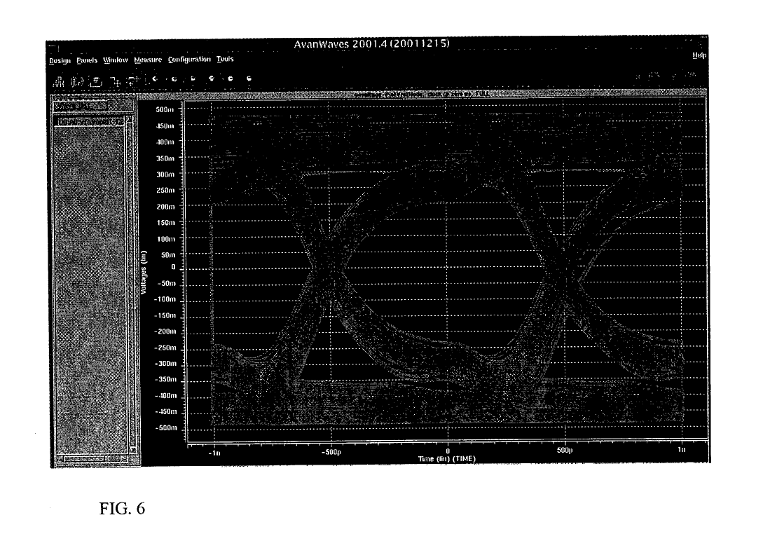

As mentioned above, the user can specify a ‘full’ or ‘sparse’ eye-plot when generating an eye-plot. FIG. 6 shows an example of a full eye-plot.

For single-ended data, a full eye-plot contains as many waves as the product of data node analyzed, and consecutive clock crossings analyzed.

For differential data and a relative plot, a full eye-plot contains as many waves as the product of differential pairs of data nodes, and consecutive clock crossings analyzed.

For differential data and an absolute plot, a full eye-plot contains as many waves as twice the product of differential pairs of data nodes, and clock crossings analyzed, because both node voltage and nodebar voltage are plotted, not just difference between node voltage and nodebar voltage.

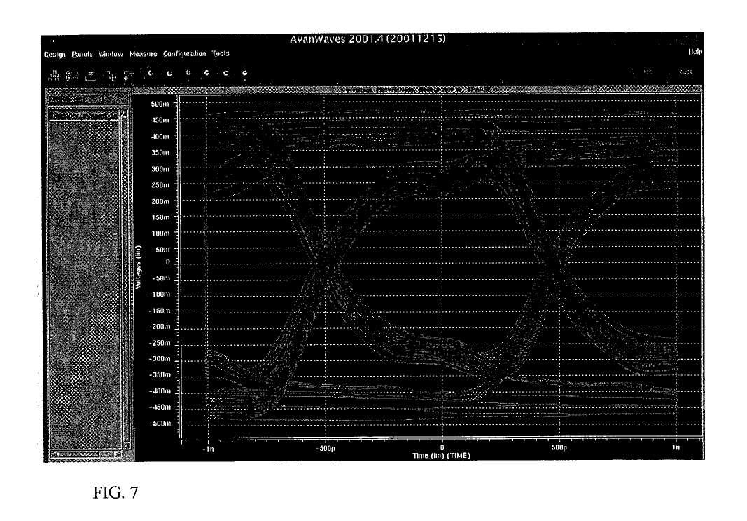

A sparse eye-plot limits the number of waves in the eye-plot. They are a subset of the waves shown in a full plot. FIG. 7 shows an example of a sparse eye-plot. Sparse plots allow the character of eye-plot to be assessed from additional perspective which can display eye-plot characteristics hidden by full plots populated with numerous waves. Waves selected for plotting in sparse plots are intelligently selected and the waves the wave density is preserved, resulting in only minimal loss to the qualitative nature of the display.

In the illustrative embodiment, a sparse eye-plot selects the 102 most relevant waves to plot from the set of all waves (a ‘full’ plot). Those skilled in the art will appreciate that a different number of waves may be chosen for the sparse eye-plot in an illustrative embodiment of the present invention. For example, 75 waves, 125 waves, 80 waves or 110 waves could be used.

In the sparse plotting, waves are selected for plotting based on the following eight parameters: (1) occurrence of a Setup High; (2) occurrence of a Setup Low; (3) occurrence of a Hold High; (4) occurrence of a Hold Low; (5) signal node voltage at each clock crossing (horizontal high waves that do not include a state transition); (6) signal node voltage at each clock crossing (horizontal low waves that do not include a state transition); (7) the highest signal node voltage in the analysis range; and (8) the lowest signal node voltage in the analysis range.

A Setup High event is defined by the data signal rising above Vref high if a voltage reference window is defined. If a voltage reference window is not defined, the Setup High event is defined by data rising above Vref. The Setup Low event is defined by data falling below Vref low or Vref if no voltage reference window is defined. A Hold High event is defined by data falling below Vref high or Vref. Lastly, a Hold Low event is defined by data rising above Vref low or Vref.

The total number of waves that can be plotted in a ‘sparse’ eye-plot is 102 in the illustrative embodiment. Up to 80 waves can be plotted from parameters (1) through (4). Up to 20 waves can be plotted from parameters (5) and (6). One wave each is always plotted from parameters (7) and (8). It is possible that less than 102 waves is plotted due to a wave being a member of more than one parameter, or a parameter not having enough waves within it to allow the maximum number of waves to be plotted.

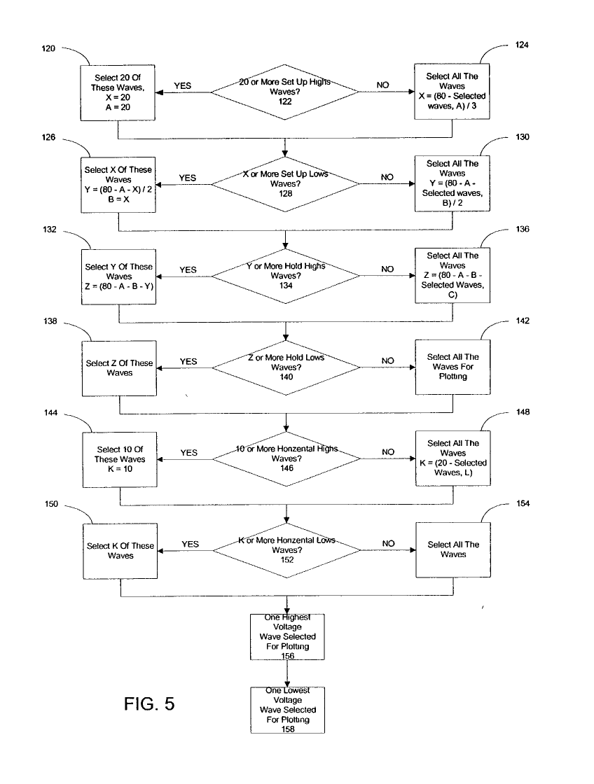

In accordance with one aspect of the present invention, the wave selection process has a sorting algorithm that ‘spreads’ unused wave selection choices between different parameters. FIG. 5 provides a flowchart that shows the steps of wave selection process for a ‘sparse’ eye-plot that varies the number of waves between different parameters.

First, parameters (1) through (4) are order by the number of timing events (Setup High, Setup Low, Hold High, and Hold Low) that each contains. The one with the least events is processed first. Each parameter is processed in ascending order. For the following explanation, it is assumed that there are fewer Setup High events than the other three parameters. Rest of ascending order is assumed Setup Low, Hold High, and Hold Low.

A process begins by checking if twenty or more Setup Highs occur within the analysis range (step 122 of FIG. 5). If there are twenty or more, then twenty of these waves are selected for plotting (step 120). Since twenty waves are plotted for Setup High, twenty is assigned to both A and X (step 120). If there are less than twenty, then all Setup High are plotted (step 124). The step 124 in FIG. 5 figures out the X for the next parameter. The X equals to eighty minus selected waves for Setup High, A, then divide by three and round down to nearest whole number. Next, Setup Low are checked if there are X or more Setup Low occur within the analysis range (step 128). If there are X or more Setup Low waves, then only X of these waves are selected for plotting and B assigned the X value (step 126). If there are less than twenty Setup Low, then all Setup Low are plotted (step 130). The step 130 in FIG. 5 figures out the Y for the next parameter. The Y is defined as eighty minus selected waves for Setup High, A, minus selected waves for Setup Low, B, then divide by two and round down to nearest whole number. Next, Hold High are checked if there are Y or more Hold High (step 134). If there are Y or more, then Y of these waves are selected for plotting (step 132). If there are less than Y, then all Hold High are plotted (step 136). The step 136 in FIG. 5 figures out the Z value for the next parameter. The Z equals to eighty subtracted by all the selected waves from the parameters (1) through (3) (step 132). Next, Hold Low are checked if there are Z or more Hold Low waves (step 140). If there are more than Z, then Z of these waves are selected for plotting (step 138). If there are less than Z, then all Hold Low are plotted (step 142).

When selections occur in parameters (1) through (4), the largest and smallest event values are always selected for plotting. For parameter (1), the event value is calculated as Clock time minus Setup High time. For parameter (2) the event value is calculated as Clock time minus Setup Low time. For parameter (3) the event value is calculated as Hold High time minus Clock time. For parameter (4) the event value is calculated as Hold Low time minus Clock time. Each of these parameters will have a population of these types of timing event measurements. With the population in sequential event time order, a subset selection is made for inclusion in the eye-plot. The subset wave selection is every N waves from the ordered list, where N is one or greater as required to limit the total wave quantity selected.

Similarly, when selections occur in parameters (5) and (6), the largest and smallest event values are always selected for plotting. For parameters (5) and (6), the event value is the voltage at Clock time. Each of these parameters will have a population of these types of voltage at time of Clock, event measurements. With the population in sequential event voltage order, a subset selection is made for inclusion in the eye-plot. The subset wave selection is every N waves from the ordered list, where N is one or greater as required to limit the total wave quantity selected.

For parameter (5), Horizontal High, a check of whether there are ten or more waves for this parameter is performed (step 146). If there are ten of more, then ten of these waves are selected for plotting (step 144). If less then ten, then all Horizontal High are plotted (step 148). The K equals to twenty minus selected waves for Horizontal High, L (step 148). Next, Horizontal Low is checked whether there are K or more waves. If there are K or more, then K of Horizontal Low are plotted (step 150). If there are less than K, then all Horizontal Low are plotted (step 154). Next, the wave containing the highest voltage in the entire analysis range is selected for plotting (step 156). Lastly, the wave containing the lowest voltage in the entire analysis range is selected for plotting (step 158).

The illustrative example with actual number shows how the sorting algorithm would operate. For example, there are only ten Setup High waves. All ten Setup High waves are selected for plotting. The total number of waves, eighty, that can be plotted for parameters (1) through (4), less the ten plotted Setup High leaves seventy more to plot. There are three more parameters of the original four to consider. The seventy more waves to plot are taken and divided by three. Rounding this result down to the nearest whole number yields twenty-three. In this example, up to twenty-three of the next parameter can be plotted. Similar scenario is repeated for all the parameters.

In this illustrative embodiment, the number of waves that may plotted for Setup Low depends on the previous number of Setup High waves. If there were more then twenty waves in Setup High, Maximum number of waves that can be plotted in Setup Low are twenty as well. If there was less then twenty waves in Setup High, then the sorting algorithm equally ‘spreads’ unused wave selection choices between parameters (2) through (4). This algorithm ensures the selection of the parameter elements nearest the clock crossing, the parameter farthest from the clock crossing, and an equidistant ‘striding’ through the balance of the waves in each parameter.

While the present invention has been described with reference to an illustrative embodiment thereof, those skilled in the art will appreciated that various changes in sorting algorithm may be made without departing from the intended scope of the present invention as defined in the appended claims.

FIG. 6 shows an example of a full “fasteye” eye-plot produced in accordance with the illustrative embodiment. The “fasteye” method combines all the waves into one and allows displaying an eye-plot that consisting of thousands of waves within a few seconds.

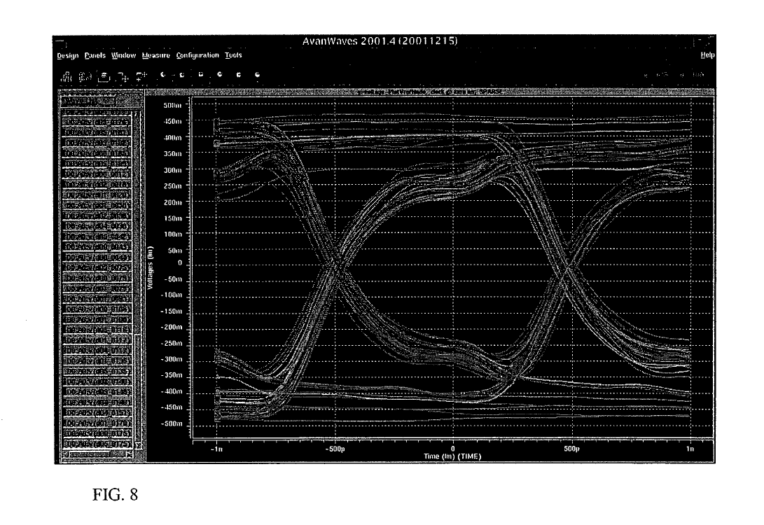

FIG. 8 shows an example of a sparse “wavenames” eye-plot produced in accordance with the illustrative embodiment. The “wavenames” method attributes names to individual waves in the eye-plot. Each node in each cycle defines a wave for single-ended data. Each differential pair of data nodes in each cycle defines a wave for differential data when relative plots are made. Each node in each cycle defines a wave for differential data when absolute plots are made. Wave names are visible in the frame or Legend of the wave viewer used to display the eye-plot. The name of each wave identifies the node and cycle in the simulation being analyzed that is responsible for the wave in the eye-plot.

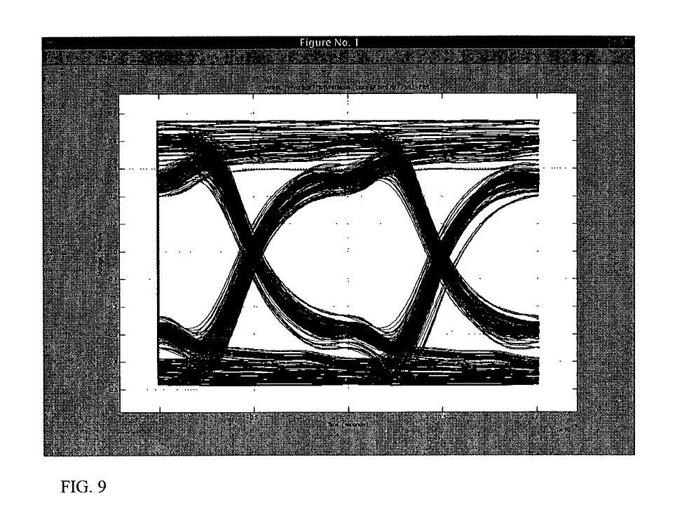

FIG. 9 shows an example of a full “matrix” eye-plot produced in accordance with the illustrative embodiment. The “matrix” method generates an eye-plot that is displayed in the Matlab environment from MathWorks, Inc of Natick, Mass. The eye-plot can be reopened in Matlab. It is suitable for import into third-party tools for statistical analysis, plotting, or other matrix manipulation.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved. It is intended that the present invention be limited only to the extent required by the appended claims and the applicable rules of law.

What is claimed is:

1. In an electronic device, a method, comprising the steps of:
providing results of simulation of an electrical component wherein said results contain waveform representations of a data signal and a clock signal over a simulated time period; and
with an automated processing facility, processing the results of the simulation to provide a signaling eye-plot graph.

2. The method of claim 1 further comprising the step of performing error checking on an input file to identify any errors in the input file.

3. The method of claim 1, wherein the all waveform representations of a data signal are time-aligned to overlay the clock signal event-time, said clock signal event time defined as zero in the eye-plot.

4. The method of claim 1, wherein the eye-plot can be made from a single node data.

5. The method of claim 1, wherein the eye-plot can be made from multiple node data.

6. The method of claim 1, wherein the eye-plot can be made from a single differential pair of data nodes.

7. The method of claim 1, wherein the eye-plot can be made from multiple pairs of differential data nodes.

8. The method of claim 1, wherein the eye-plot can be a full eye-plot for a single node data, said full eye-plot contain of all waves as the product of data nodes analyzed and consecutive clock crossings analyzed.

9. The method of claim 1, wherein the eye-plot can be a full eye-plot for a differential data and a relative plot, said full eye-plot contain of all waves as the product of differential pairs of data nodes and consecutive clock crossings analyzed.

10. The method of claim 1, wherein the eye-plot can be a full eye-plot for a differential data and an absolute plot, said full eye-plot contain of all waves as twice the product of differential pairs of data nodes and consecutive clock crossings analyzed, said absolute plot selects both a node voltage and a nodebar voltage.

11. The method of claim 1, wherein the eye-plot can be a sparse eye-plot, said sparse eye-plot limits the number of waves shown in the eye-plot.

12. The method of claim 11, wherein the sparse eye-plot selects most relevant waves to plot from the set of all waves using a wave selecting algorithm.

13. The method of claim 1, wherein the eye-plot can be generated by a wavenames method, said wavenames eye-plot attributes data nodes and time referenced names to individual waves.

14. The method of claim 1, wherein the eye-plot can be generated by a fasteye method, said fasteye eye-plot combines all selected waves into one wave.

15. The method of claim 1, wherein the eye-plot can be generated by a matrix method, said matrix eye-plot consists of a floating point matrix and can be displayed in Matlab.

16. A storage medium for use with an electronic device, said medium holding instructions executable by the electronic device for performing a method, said method comprising the steps of:
providing an automated tool for processing an information in a simulation result or captured results regarding a data signal and a clock signal for producing an eye-plot;
receiving a multiple parameters at an input file to determine a type and characteristics of the eye-plot;
providing the eye-plot from an input file of an electrical component simulation result or captured results.

17. The storage medium of claim 16, wherein the method further comprises the step of performing error checking on the input file to identify any errors in the input file.

18. The storage medium of claim 16, wherein the data signal is time-aligned to overlay the clock signal event-time, said clock signal event time defined as zero in the eye-plot.

19. The storage medium of claim 16, wherein the eye-plot can be made from a single node data.

20. The storage medium of claim 16, wherein the eye-plot can be made from multiple node data.

21. The storage medium of claim 16, wherein the eye-plot can be made from a single differential pair of data nodes.

22. The storage medium of claim 16, wherein the eye-plot can be made from multiple pairs of differential data nodes.

23. The storage medium of claim 16, wherein the eye-plot can be a full eye-plot for a single node data, said full eye-plot contain of all waves as the product of data nodes analyzed and consecutive clock crossings analyzed.

24. The storage medium of claim 16, wherein the eye-plot can be a full eye-plot for a differential data and a relative plot, said full eye-plot contain of all waves as the product of differential pairs of data nodes and consecutive clock crossings analyzed.

25. The storage medium of claim 16, wherein the eye-plot can be a full eye-plot for a differential data and an absolute plot, said full eye-plot contain of all waves as twice the product of differential pairs of data nodes and consecutive clock crossings analyzed, said absolute plot selects both a node voltage and a nodebar voltage.

26. The storage medium of claim 16, wherein the eye-plot can be a sparse eye-plot, said sparse eye-plot limits the number of waves shown in the eye-plot.

27. The storage medium of claim 26, wherein the sparse eye-plot selects most relevant waves to plot from the set of all waves using a wave selecting algorithm.

28. The storage medium of claim 16, wherein the eye-plot can be generated by a wavenames method, said wavenames eye-plot attributes data nodes and time referenced names to individual waves.

29. The storage medium of claim 16, wherein the eye-plot can be generated by a fasteye method, said fasteye eye-plot combines all selected waves into one wave.

30. The storage medium of claim 16, wherein the eye-plot can be generated by a matrix method, said matrix eye-plot consists of a floating point matrix and can be displayed in Matlab.

31. In an electronic device, a method, comprising the steps of:
providing an automated tool for processing an information in a simulation result regarding the data signal and the clock signal and for producing a sparse eye-plot; and
providing the sparse eye-plot from an input file of an electrical component simulation result, said sparse eye-plot selects limited number of waves using a wave selecting algorithm that utilizing different wave parameters.

32. In an electronic device, a method, comprising the steps of:
providing an automated tool for processing an information in a simulation result regarding the data signal and the clock signal and for producing a fasteye eye-plot; and
providing the fasteye eye-plot from an input file of an electrical component simulation result, said fasteye eye-plot combines all selected waves into one wave.

33. In an electronic device, a method, comprising the steps of:
providing an automated tool for processing an information in a simulation result regarding the data signal and the clock signal and for producing a matrix eye-plot; and
providing the matrix eye-plot from an input file of an electrical component simulation result, said matrix eye-plot can be displayed in a Matlab for statistical analysis, plotting or matrix manipulation.
